(19) United States
(12) Patent Application Publication
(10) Pub. No.: US 2004/0218857 A1
(43) Pub. Date: Nov. 4, 2004

(54) Duplex optical transceiver module

(76) Inventor: Chen-Hung Hung, Chia-Yi Hsien (TW)

Correspondence Address: Chen-Hung Hung, 235 Chung-Ho, Box 8-24, Taipei, TW

(21) Appl. No.: 10/403,380

(22) Filed: Apr. 1, 2003

(51) Int. Cl. G02B 6/26; G02B 6/36

(52) U.S. Cl. 385/31; 385/92

(57) ABSTRACT

A duplex optical transceiver module comprises a body having a first open channel, a second open channel, and a sleeve. A normal line of the first open channel is vertical to that of the second open channel. The first open channel receives an optical transmitting module and the second open channel receives an optical receiving module. An optical fiber is coaxially arranged in a fiber connector in the body at an opposite end of the first open channel. A filter is obliquely arranged at an intersect section of the first open channel and the second open channel. One side of the fiber facing to the optical transmitting module is coated with material which transmits light from the optical transmitting module. Another side of the filter facing the optical receiving module is coated with material which totally reflects light from the optical fiber.

### FIELD OF THE INVNETION

The present invention relates to optical transceivers, and particularly to a duplex optical transceiver module, wherein a filter is obliquely arranged at an intersect section of a first open channel and a second open channel. One side of the fiber facing to the optical transmitting module is coated with material which transmits light from the optical transmitting module. Another side of the filter facing the optical receiving module is coated with material which totally reflects light from the optical fiber.

### BACKGROUND OF THE INVENTION

In current optic communication systems, laser diodes are generally used as light sources. A packaged laser diode is as a laser diode element 1a. A packaged light detector is as a light detection element 2a, as shown in FIGS. 1 and 2. It is seen that a laser diode element 1a and a light detection components 2a are mounted inside a metal fixture 3 as a light transmitting module 1a and a light receiving module 2. Then the light transmitting module 1a, the light receiving module 2 and a body 4, are packaged as a duplex light transceiver module 5. The interior of the body 4 is provided with an optical filter 6. The upper and lower surfaces of the optical filter 6 are evaporation-coated with mediums of different transmission index. Thus it causes that light radiated from laser diode element 1a is coupled to an optical fiber 9a via the optic filter 6. Then the light is totally reflected to a light detector 2a through the optical filter 6.

The fiber 9a is coaxially arranged in the fiber connector 9 and the fiber connector 9 is placed in the sleeve 11. The sleeve 11 is fixed to the body 4 by laser welding.

The optic filter 6 is fixed to a frame 8 of a filter holder 7 and the filter holder 7 is inserted into the body 4. A positioning pin 10 is inserted between the body 4 and the filter holder 7 for adjusting the filter 6. Thereby, light can be reflected from or refracted in the filter 6 so as to be coupled to the fiber 9a and detector 2a.

Since the prior art duplex optical transceiver module 5 includes a body 4, a holder 7, a positioning pin 10 and a sleeve 11. The cost is high and the machining procedures are complicated. The sleeve 11 is machined by lathe. As a result, the error is large. As a result, transmission property of the duplex optical transceiver module is unstable.

Moreover, conventionally, it is difficult to hold the filter 6 with an orientation of 45 degrees in the body 4. Thereby, the holder 7 is formed so that the filter 6 is fixed to the frame 8 and the positioning pin 10 is used to lock the holder 7. Thus the filter 6 is arranged in the body 4 with an orientation of 45 degrees so that optical coupling is effective. The filter 6 is possibly unstably due to the machining of the body 4, the holder 7 and the positioning pin 10. Thereby, the focus of the filter 6 is changed and thus accumulated error is large.

### SUMMARY OF THE INVENTION

Accordingly, the primary object of the present invention is to provide a duplex optical transceiver module comprises the following element. A body having a first open channel, a second open channel, and a sleeve. A normal line of the first open channel is vertical to that of the second open channel. The first open channel receives an optical transmitting module and the second open channel receives an optical receiving module. An optical fiber is coaxially arranged in a fiber connector arranged in the body at an opposite end of the first open channel. A filter is obliquely arranged at an intersect section of the first open channel and the second open channel. One side of the fiber facing to the optical transmitting module is coated with material which transmits light from the optical transmitting module. Another side of the filter facing the optical receiving module is coated with material which totally reflects light from the optical fiber.

The various objects and advantages of the present invention will be more readily understood from the following detailed description when read in conjunction with the appended drawing.

### BRIEF DESCRIPTION OF THE DRAWINGS

FIGS. 1 and 2 are perspective view and exploded view of a prior art duplex optical transceiver module.

FIGS. 3 and 4 are perspective view and exploded view of the duplex optical transceiver module according to the present invention.

FIG. 5A is a cross section view of the present invention.

FIG. 5B is a right side view of FIG. 5A.

FIG. 6 is a cross section view along line 6-6 of FIG. 3.

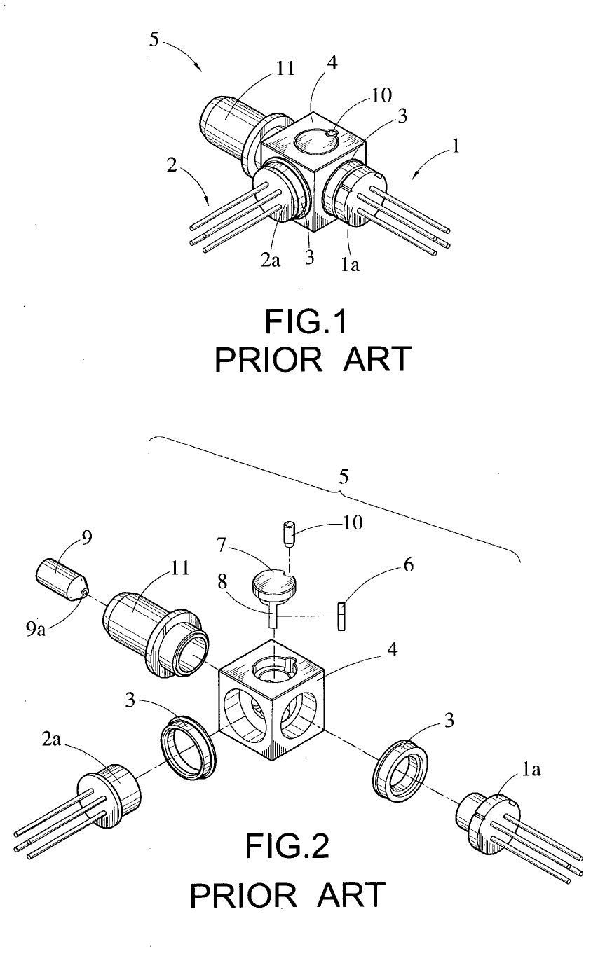

### BRIEF DESCRIPTION OF THE PREFERRED EMBODIMENTS

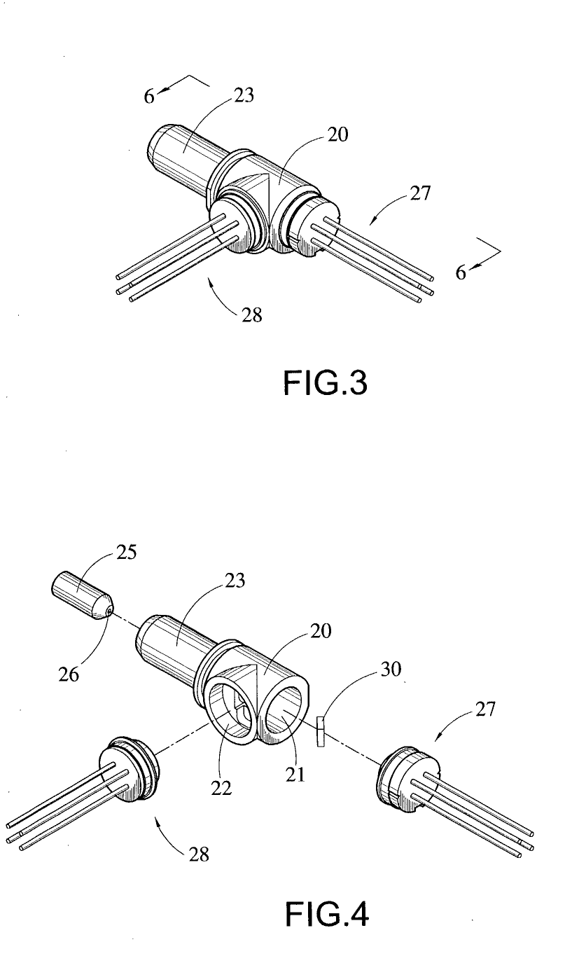

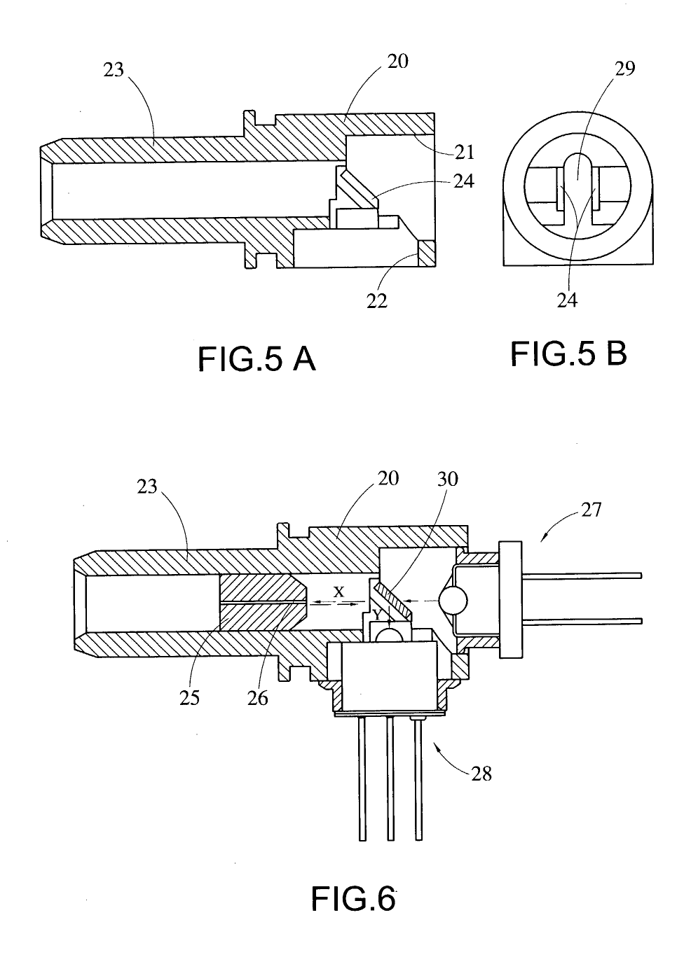

Referring to FIGS. 3 to 6, the duplex optical transceiver module of the present invention is illustrated. The duplex optical transceiver module includes a body 20 made of injecting metal powders. The body 20 has a first open channel 21, a second open channel 22 and a sleeve 23. The first open channel 21 and the second open channel 22 are adjacent, but are at different orientation. The first open channel 21 and second open channel 22 are communicable. The normal line of the first open channel 21 is vertical to that of the second open channel 22. The sleeve 23 is sleeved to the body 20 at a direction opposite to the first open channel 21.

The first open channel 21 receives an optical transmitting module 27 and the second open channel 22 receives an optical receiving module 28. The optical transmitting module 27 and optical receiving module 28 are welded to the body 20 by laser welding.

Interior of the sleeve 23 is arranged with a fiber connector 25. An optical fiber 26 is coaxially arranged in the fiber connector 25 so that light from the laser diode of the optical transmitting module 27 is refracted by the filter 30 and then transmitted to the optical fiber 26 and light received by the optical fiber 26 is totally reflected and then to be coupled to the optical receiving module 28.

An inclined supporting seat 24 is installed in the body 20 and with an inclined angle of 45 degrees at a path of the light from the optical transmitting module 27 for supporting a filter. The inclined supporting seat 24 has an opening 29 for transmitting optical signal. A filter 30 can be combined to the inclined supporting seat 24. Since the orientation setting of the filter 30 is very precise, the accuracy of the coupling between the optical fiber and a light detector is improved.

Referring to FIG. 6, the upper and lower surfaces of the filter 30 is evaporated-plated with materials of different transmission index so that light emitted from the laser diode of the optical transmitting module 27, as indicated by the arrow X, passes through the filter 30 to be reflected and then focused to the optical fiber 26. The light received by the optical fiber 26, as indicated by arrow Y, is totally reflected by the filter 30 and then focused to the optical receiving module 28.

In fact, the first open channel 21, second open channel 22, sleeve 23 and inclined supporting seat 24 are integrally formed with the body 20 so as to reduce the problem in assembly and finish. Thus, the manufacturing cost is reduced greatly. Thereby, less parts are used so that the errors are decreased. The orientation of the filter 30 can be positioned steadily so that effective optical coupling can be achieved.

In summary, the sleeve 23 and inclined supporting seat 24 are integrally formed with the body 20. Thereby, the fiber connector 25 and the filter 30 are directly fixed to the sleeve 23 and the inclined supporting seat 24 Thereby, the assembly of the body 20 is reduced so that cost is down and the filter 30 can be fixed in a 45 degree orientation. Thereby, the focus will not be changed so that the coupling efficiency between the optical fiber and the detector is improved and the transmission property is preferred.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A duplex optical transceiver module comprising:
a body further comprising:
a first open channel, and a second open channel; wherein the first open channel and the second open channel are adjacent, and at different orientation; the first open channel and second open channel are communicable; a normal line of the first open channel is vertical to that of the second open channel; the first open channel receives an optical transmitting module and the second open channel receives an optical receiving module;
a sleeve is sleeved to the body at a direction opposite to the first open channel;
a fiber connector being arranged in an interior of the sleeve; an optical fiber being coaxially arranged in the fiber connector; and
a filter being obliquely arranged at an intersect section of the first open channel and the second open channel; one side of the fiber facing to the optical transmitting module being coated with material which transmits light from the optical transmitting module; another side of the filter facing the optical receiving module being coated with material which totally reflects light from the optical fiber.

2. The duplex optical transceiver module as claimed in claim 1, wherein an inclined supporting seat serves for supporting the filter; and the inclined supporting seat has an opening for transmitting optical signal.

3. The duplex optical transceiver module as claimed in claim 1 wherein the orientation of the inclined supporting seat has a shift of 45 degrees from an axis of the first open channel.
